(19) United States
(12) Patent Application Publication
(10) Pub. No.: US 2007/0042811 A1
(43) Pub. Date: Feb. 22, 2007

(54) Earphone jack handfree

(75) Inventor: Tonny Chen, Changhua (TW)

Correspondence Address: BRUCE H. TROXELL;SUITE 1404, 5205 LEESBURG PIKE, FALLS CHURCH, VA, 22041, US

(73) Assignee: E-Lead Electronic Co., Ltd.

(21) Appl. No.: 11/205,104

(22) Filed: Aug. 17, 2005

(51) Int. Cl. H04M 1/00

(52) U.S. Cl. 455/569.1

(57) ABSTRACT

An earphone jack handsfree includes an earphone jack signal line and a handsfree host. The earphone jack signal line has one end connecting to an earphone jack of a mobile phone and other end connecting to the handsfree host. The handsfree host includes at least a microphone, a speaker, a connection port, a control unit and a call detection unit. The handsfree thus formed can improve compatibility and reduce production and inventory costs.

### BACKGROUND OF THE INVENTION

1. Field of the Invention

The invention relates to an earphone jack handsfree to improve compatibility of handsfrees and reduce production and inventory costs.

2. Description of the Prior Art

The conventional handsfree now on the market as the one shown in FIG. 1 generally include a handsfree host 1 and a mating signal line 2. The signal line 2 has a first connector 21 on one end to be connected to the handsfree host 1 and a second connector 22 on other end corresponding to a jack of a mobile phone. When a user changes a mobile phone, a new signal line 2 mating the new mobile phone is acquired but the old handsfree can still be used.

While the conventional method mentioned above can solve the compatibility problem of the handsfree by replacing the signal line, the signal line has to receive required signals from the phone jack through a dedicated connector. The signals include sound signals, calling notice signals and the like. The mobile phones of the same brand might share a few common signal lines. But in most occasions one type of mobile phone has one mating and dedicated signal line. As there are a wide variety of mobile phones on the market, and they are obsolete very quickly, the conventional signal lines have disadvantages, notably:
1. The product life cycle of mobile phones is very short, developing dedicated signal lines with a special connector is more difficult and takes longer time. It could happen that after a new signal line is developed and introduced, the mating mobile phone has already been withdrawn from the market. Hence consumers cannot fully enjoy the benefit of handsfree when replacing the mobile phone, and have to procure a new vehicle handsfree. It is a waste of investment.
2. As the types and models of mobile phones are numerous, many different types of mating and dedicated signal lines also have to be developed and produced to meet market requirements. The costs of development and inventory of manufacturers are higher. Signal line vendors also have to stock many types of signal lines to meet market requirements. Once the mobile phones are withdrawn from the market, the stocked signal lines become useless. A huge loss occurs.

### SUMMARY OF THE INVENTION

The present invention aims to solve the aforesaid problems. The invention provides an earphone jack handsfree that includes an earphone jack signal line and a handfsree host. The earphone jack signal line has one end to be inserted into the earphone jack of a mobile phone and other end connecting to the handsfree host. The handsfree host includes at least a microphone, a speaker, a connection port, a control unit and a call detection unit.

In one aspect, the call detection unit includes a wave detection circuit to detect electromagnetic wave while the mobile phone is in use for conversation to activate operation of the handsfree host.

In another aspect, the call detection unit further includes an integration circuit to perform integration of sound signals output from the earphone jack of the mobile phone so that the sound signals are transformed from audio frequency to DC signals for comparison, thereby to determine whether the receiving signals are calling signals to avoid generating wrong actions.

The invention can achieve the following effects:
1. The earphone jack handsfree can be developed easily and rapidly. Compared with the conventional handsfrees that are limited to dedicated signal line connectors, and communication signals and electric contacts of the mobile phone are restricted, the invention can be developed rapidly. It is progressive and novel. The invention can respond the fast changing mobile phones quickly so that the consumers having new types of mobile phones can acquire new types of signal line rapidly and continuously enjoy the benefits of vehicle handsfrees.
2. The earphone jack handsfree of the invention adopts earphone jack signal lines in fewer specifications. Each specification has the same circuit. Unlike the conventional handsfrees that have to use dedicated signal line connectors with different corresponding circuits to match different types of mobile phones, inventory of the manufacturers and vendors can be reduced. The compatibility of the handsfree increases. The concern of idle or overstock caused by obsolete mobile phones is reduced. Production and inventory costs are lower.
3. The earphone jack handsfree of the invention uses the earphone jack of mobile phones of a universal specification as the connection end. A few specifications can be adapted to a wide variety of mobile phones and handsfree hosts. The incompatibility problem when the mobile phone is changed can be prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional handsfree.

FIG. 2 is a schematic view of the earphone jack signal line of the invention.

FIG. 3 is a schematic view of an embodiment of the invention.

FIG. 4 is a schematic view of another embodiment of the invention.

FIG. 5 is another schematic view of another embodiment of the invention.

FIG. 6 is a circuit block diagram of an echo cancellation unit of the invention.

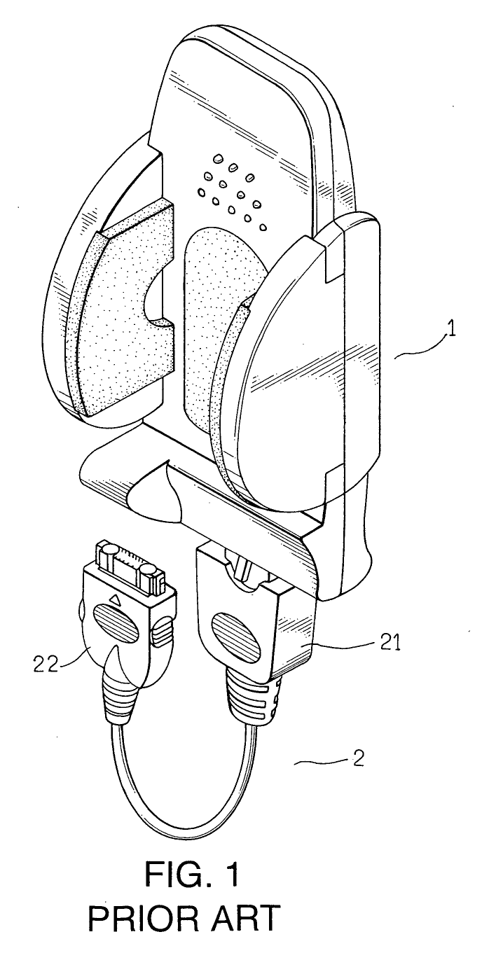

### DESCRIPTION OF THE PREFERRED EMBODIMENTS

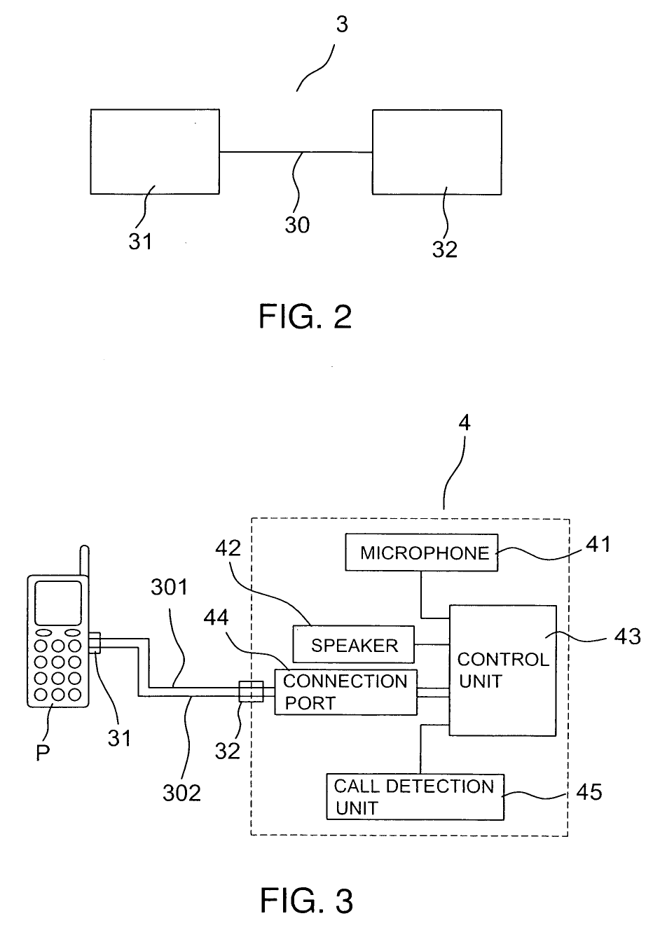

Referring to FIGS. 2 and 3, the earphone jack handsfree according to the invention includes an earphone jack signal line 3 and a handsfree host 4.

The earphone jack signal line 3 has a conductive wire 30 with a first connector 31 on one end and a second connector 32 on other end. The earphone jack signal line 3 includes at least an earphone circuit 301 and a mike circuit 302. The first connector 31 is to be inserted into an earphone jack of a mobile phone P. The second connector 32 is to be connected to the handsfree host 4. Through the earphone circuit 301 and mike circuit 302, output or input of sound signals in the earphone jack of the mobile phone P can be transmitted.

The handsfree host 4 includes at least a microphone 41, a speaker 42, a control unit 43, a connection port 44 and a call detection unit 45.

The microphone 41 receives sound signals of users.

The speaker 42 outputs the sound signals of a caller or mobile phone P.

The control unit 43 controls operations of various elements in the handsfree host 4.

The connection port 44 is connected to the second connector 32 of the earphone jack signal line 3.

The call detection unit 45 includes a wave detection circuit to detect electromagnetic signals while the mobile phone is in use for conversation to activate operation of the control unit 43.

By means of the elements set forth above, when in use, the first connector 31 is connected to the earphone jack of the mobile phone P, and the second connector 32 is connected to the connection port 44 of the handsfree host 4. When there is a call to the mobile phone P, the call detection unit 45 gets electromagnetic signals from the base station that communicate with the mobile phone P, and activates the operation of the control unit 43 so that the handsfree host 4 starts operation. Hence the sound transmitted to the mobile phone P is sent through the earphone jack circuit 301 and mike circuit 302 of the earphone jack signal line 3 to the handsfree host 4, and broadcast through the microphone 42. Meanwhile, user's sound also can be transmitted through the microphone 41 to the transceiver of the caller to do conversation.

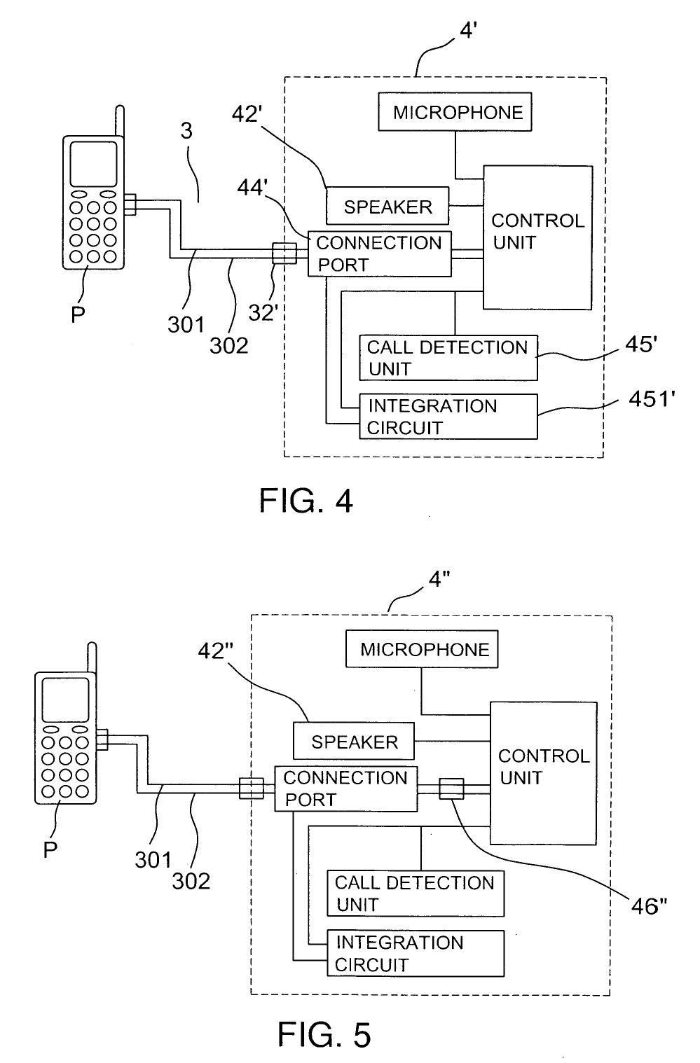

Refer to FIG. 4 for a second embodiment of the invention. To prevent the handsfree host 4′ from operating in the wrong way caused by signal exchanged between the base stations of telecommunication providers while the mobile phone P is moved, the call detection unit 45′ further has an integration circuit 451′ which is coupled in parallel with the earphone circuit 301. Thereby the sound signal output from the earphone jack of the mobile phone P is integrated, and the integrated waveform is transformed from an audio frequency to a DC signal. Hence the sound exceeding a selected ranged can be set to be integrated and treated as the calling signal. Through the integration circuit 451′ and the call detection unit 45′, the calling signal can be determined correctly to activate operation of the handsfree host 4′. Hence the calling sound of the mobile phone P can be transmitted through the earphone jack of the mobile phone P, the earphone circuit 301 and the mike circuit 302 to the handsfee host 4′, and wrong operation can be prevented.

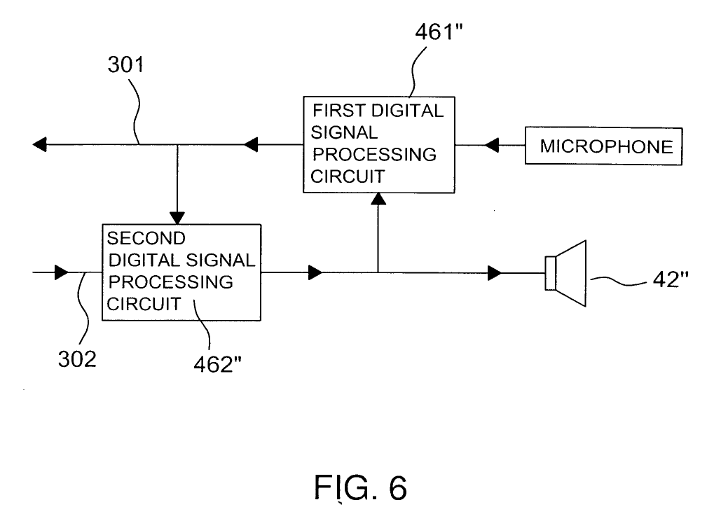

Refer to FIGS. 5 and 6 for a third embodiment of the invention. To prevent echo sound from occurring to the handsfree, the handsfree host 4″ further has an echo cancellation unit 46″ which includes a first digital processing circuit 461″ and a second digital processing circuit 462″. The first digital processing circuit 461″ is located on the mike circuit 302 and connected to the earphone circuit 301 to compare the digitized sound information and determine the echo sound and the sound of car drivers transmitting from the microphone. The echo sound is eliminated and the desired sound is transmitted through the mike circuit 302 to the mobile phone P. The mobile phone P transmits the sound signal to the remote user so that there is no echo sound on the remote side. The second digital processing circuit 462″ aims to cancel line echo (or side tone), namely the commonly called input echo. It mainly caused by the mike sound entering from the mike circuit 302 to the mobile phone P, and the mobile phone P sending the sound signal through the earphone circuit 301 to the speaker 42″. Hence the second digital processing circuit 462″ is used to cancel line echo. It is located on the earphone circuit 301 and connected to the mike circuit 302. The sound signal transmitted from the microphone is digitized and compared with the sound signal transmitted from the earphone circuit 301, and is differentiated and separated to get the real signal of the earphone circuit 301 for sending to the speaker 42″. The signal thus generated is the pure calling signal of the mobile phone.

In summary, the invention uses the earphone jack of the mobile phone that is rarely changed to function as the connection port of the handsfree host and the mobile phone. Only a minimum number of earphone jack signal line specifications are needed to connect various types of mobile phones to the handsfree host.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. An earphone jack handsfree, comprising:
an earphone jack signal line having a conductive wire which has a first connector on one end and a second connector on other end, and at least one earphone circuit and one mike circuit, the first connector being inserted into an earphone jack of a mobile phone, the second connector being connected to a handsfree host, output or input of sound signals in the earphone jack of the mobile phone being transmitted through the earphone circuit and the mike circuit;
the handsfree host including at least:
a microphone to receive sound signals of users;
a speaker to output sound signals of a caller or the mobile phone;
a control unit to control operations of elements in the handsfree host;
a connection port connecting to the second connector of the earphone jack signal line; and
a call detection unit including a wave detection circuit to detect electromagnetic signals while the mobile phone is in use for conversation to activate operation of the control unit.

2. The earphone jack handsfree of claim 1, wherein the call detection unit further includes an integration circuit.

3. The earphone jack handsfree of claim 1, wherein the handsfree host further includes an echo cancellation unit.

4. The earphone jack handsfree of claim 3, wherein the echo cancellation unit includes a first digital signal processing circuit located on the mike circuit and connected to the earphone circuit to eliminate input echo.

5. The earphone jack handsfree of claim 3, wherein the echo cancellation unit includes a second digital signal processing circuit located on the earphone circuit and connected to the mike circuit to eliminate line echo.
